(19) United States
(12) Patent Application Publication
(10) Pub. No.: US 2006/0081722 A1
(43) Pub. Date: Apr. 20, 2006

(54) Gaseous fuel injector for internal combustion engine

(75) Inventors: Masaaki Kato, Kariya-city (JP); Kenji Date, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/248,301

(22) Filed: Oct. 13, 2005

(30) Foreign Application Priority Data
Oct. 18, 2004 (JP) 2004-302576
Aug. 1, 2005 (JP) 2005-222706

(51) Int. Cl. F02M 41/16

(52) U.S. Cl. 239/96; 239/585.1; 239/88

(57) ABSTRACT

A fuel injector has: an inlet port through which the high-pressure gaseous fuel is supplied; an injection hole through which the high-pressure gaseous fuel is injected; a gaseous fuel supply path that extends from the inlet port to the injection hole to flow the high-pressure gaseous fuel therethrough; a needle that opens or closes the injection hole; and an actuator that actuates the needle. The gaseous fuel supply path is provided with a first volume increase portion at which a cross-sectional area of the gaseous fuel supply path rapidly increases as going from the injection hole toward the inlet port.

### CROSS REFERENCE TO RELATED APPLICATION

This application is based upon and claims the benefit of priority of Japanese Patent Applications No. 2004-302576 filed on Oct. 18, 2004, and No. 2005-222706 filed on Aug. 1, 2005, the contents of which are incorporated herein by reference.

### FIELD OF THE INVENTION

The present invention relates to a gaseous fuel injector to inject a high-pressure gaseous fuel directly into a cylinder of an internal combustion engine.

### BACKGROUND OF THE INVENTION

Current development of the next-generation vehicles places prime importance on clean emission gas and CO₂ emission decrease. Conventional liquid fossil fuel combustion has an improvement ceiling to achieve these targets. Gaseous fuels such as gaseous fossil fuel (natural gas, petroleum gas, etc.) and hydrogen gas, which are expected to burn more efficiently, can substitute for the liquid fossil fuel. Then, gaseous fuel engines, which use the above-described gaseous fuels, are under development, and a part of which is coming into actual use.

Conventionally, it is difficult to inject enough amount of gaseous fuel in direct injection engines, because of a small density of the gaseous fuel, to cause a shortage of an output power of the engine. It is possible to inject enough amount of gaseous fuel in spark ignition engines, in which pre-mixture time is relatively long, however the injected gaseous fuel has a relatively small momentum and cannot be mixed enough with intake air, causing issues of unburnt fuel emission and output power shortage. In compression ignition engines, it is further difficult to inject enough amount of gaseous fuel in a short time and to mix the gaseous fuel with intake air, causing issues of unburnt fuel emission and output power shortage.

Thus, various technologies are in studies to solve the output power shortage and to reduce the unburnt fuel emission. For example, a technology for injecting two kinds of fuel is disclosed in JP-2003-232234-A, another technology to operate two fuel injections for one combustion is disclosed in JP-2000-345884-A, and a technology using two fuel injection valves is disclosed in JP-2004-68762-A.

JP-2003-232234-A discloses a fuel supply control apparatus that selectively or simultaneously supplies a liquefied petroleum gas (LPG) and liquid fuel such as gasoline to so-called a “bi-fuel internal combustion engine”. The apparatus has a first fuel supply path to supply LPG and a second fuel supply path to supply the liquid fuel. In switching the engine to a mode driven only with LPG, the apparatus supplies both of LPG and liquid fuel to the engine, so that an air-fuel ratio is prevented from excessive lean not to occur an accidental fire and not to spoil a drivability of the engine and a vehicle.

JP-2000-345884-A discloses a control apparatus for an internal combustion engine that injects gaseous fuel directly into a combustion chamber of an engine. The control apparatus selects a first fuel injection performed only in a compression stroke or a second fuel injection performed both in an induction stroke and in a compression stroke in accordance with a required injection time. That is, the gaseous fuel is injected only in the compression stroke if the required injection time is short. The gaseous fuel is injected not only in the compression stroke but also in the induction stroke by a difference between the required injection time and injection operable time in the compression stroke, to prevent the air induction amount into the combustion chamber from shortage and to prevent a performance of the internal combustion engine from decreasing.

JP-2004-68762-A discloses a fuel supply device provided with a pair of in-cylinder fuel injection valve (or an in-cylinder fuel injection valve and in-intake passage fuel injector) to inject gaseous fuel directly into a cylinder of an engine. A first fuel injection valve has a relatively small injection ratio, and a second fuel injection valve has a relatively large injection ratio. The gaseous fuel is injected from the first fuel injection valve when a requited fuel amount is smaller than a predetermined amount, and injected from the second fuel injection valve when the required fuel amount is larger than the predetermined amount. Thus, intake air charging efficiency is prevented from decreasing when the required fuel amount becomes large, to secure a large output power of the engine.

However, the fuel supply control apparatus disclosed in JP-2003-232234-A is not for an engine that mainly uses gaseous fuel. The bi-fuel injection disclosed in JP-2003-232234-A improves drivability by controlling the injections of LPG and liquid fuel in accordance with a driving condition of the engine. However, a vaporization prevention of LPG increases a driving region driven by liquid fuel. Further, the fuel supply control apparatus requires two large fuel tanks, two fuel supply systems and two fuel injection valves respectively for LPG and liquid fuel. This construction increases dimensions of the fuel supply control apparatus. The fuel supply control apparatus is for injecting LPG in its liquid phase, and JP-2003-232234-A does not disclose an apparatus for injecting a required amount of gaseous fuel in a short time.

The control apparatus disclosed in JP-2000-345884-A is to perform an effective combustion by operating the fuel injection in the compression stroke. The control apparatus does not enable to inject a required amount of gaseous fuel in a short time. When the injection amount is large, the required injection time becomes long and the gaseous fuel is injected also in the induction stroke, and the gaseous fuel with large volume decreases an air intake amount. Thus, an output power increase by the control apparatus is limited, just as preventing the output power from decreasing.

JP-2004-68762-A discloses the fuel injection control by two in-cylinder injection valves having relatively small injection ratio and relatively large injection ratio, however, does not disclose a specific constructions thereof. In the range in which the required fuel injection amount is large, it is possible to inject the gaseous fuel from both of the two in-cylinder fuel injection valves, however, it requires two in-cylinder injection valves and two fuel supply systems to make the construction of the apparatus complex. Further, the apparatus limits an arrangement to promote a mixture of the injected spray, to increase a manufacturing cost.

As described above, under current circumstances, it is difficult to improve an output power and to decrease an unburnt fuel emission simultaneously in the fuel injector that mainly injects high-pressure gaseous fuel. Further, a large amount injection of the gaseous fuel can affect injections in other cylinders of the engine.

### SUMMARY OF THE INVENTION

The present invention is achieved in view of the above-described issues, and has an object to provide a fuel injector for injecting high-pressure gaseous fuel into a combustion chamber of an internal combustion engine, which has small dimensions and a large output power to inject a large amount of the gaseous fuel and decreases unburnt fuel emission by promoting a mixture with intake air. Another object is to provide a small and practical gaseous fuel injector that can be installed regardless of the constructions and shapes of an intake and discharge valves of the engine, and can inject the gaseous fuel without affecting fuel injections in other cylinders.

The fuel injector has: an inlet port through which the high-pressure gaseous fuel is supplied; an injection hole through which the high-pressure gaseous fuel is injected; a gaseous fuel supply path that extends from the inlet port to the injection hole to flow the high-pressure gaseous fuel therethrough; a needle that opens or closes the injection hole; and an actuator that actuates the needle. The gaseous fuel supply path is provided with a first volume increase portion at which a cross-sectional area of the gaseous fuel supply path rapidly increases as going from the injection hole toward the inlet port.

### BRIEF DESCRIPTION OF THE DRAWINGS

Other objects, features and advantages of the present invention will be appreciated, as well as methods of operation and the function of the related parts, from a study of the following detailed description, the appended claims, and the drawings, all of which form a part of this application. In the drawings:

FIG. 1 is a cross-sectional view showing a high-pressure gaseous fuel supply path in a fuel injector according to a first embodiment of the present invention, which is taken along a line I-I in FIG. 3;

FIG. 2 is a cross-sectional view showing an operating oil supply path in the fuel injector according to the first embodiment, which is taken along a line II-II in FIG. 3;

FIG. 3 is a top view of the fuel injector according to the first embodiment;

FIG. 4 is an enlarged cross-sectional view showing a construction of a nozzle in the fuel injector according to the first embodiment;

FIG. 5A is a cross-sectional view showing an injector chamber in the fuel injector according to the first embodiment;

FIG. 5B is another example of the injector chamber in the fuel injector according to the first embodiment;

FIG. 5C is still another example of the injector chamber in the fuel injector according to the first embodiment;

FIG. 5D is a fuel chamber for the fuel injector according to the first embodiment;

FIG. 6A is an enlarged cross-sectional view showing a seat portion, a nozzle chamber and a sac in the fuel injector according to the first embodiment;

FIG. 6B is a schematic diagram showing volume increase portions and apertures in the high-pressure gaseous fuel path in the fuel injector 1 according to the second embodiment;

FIG. 6C is a schematic diagram showing a basic constriction and a function of the volume increase portion in the high-pressure gaseous fuel supply path in the fuel chamber 1 according to the first embodiment;

FIG. 7A is a cross-sectional view showing graph showing an injection hole in the fuel injector according to the first embodiment;

FIG. 7B is an enlarged cross-sectional view showing the injection hole in the fuel injector according to the first embodiment;

FIG. 7C is an enlarged schematic view showing the injection hole in the fuel injector according to the first embodiment;

FIG. 7D is an enlarged schematic view showing another example of the injection pot in the fuel injector according to the first embodiment; and

FIG. 8 is a cross-sectional view showing a fuel injector according to a second embodiment of the present invention.

### DESCRIPTION OF THE PREFERRED EMBODIMENTS

### First Embodiment

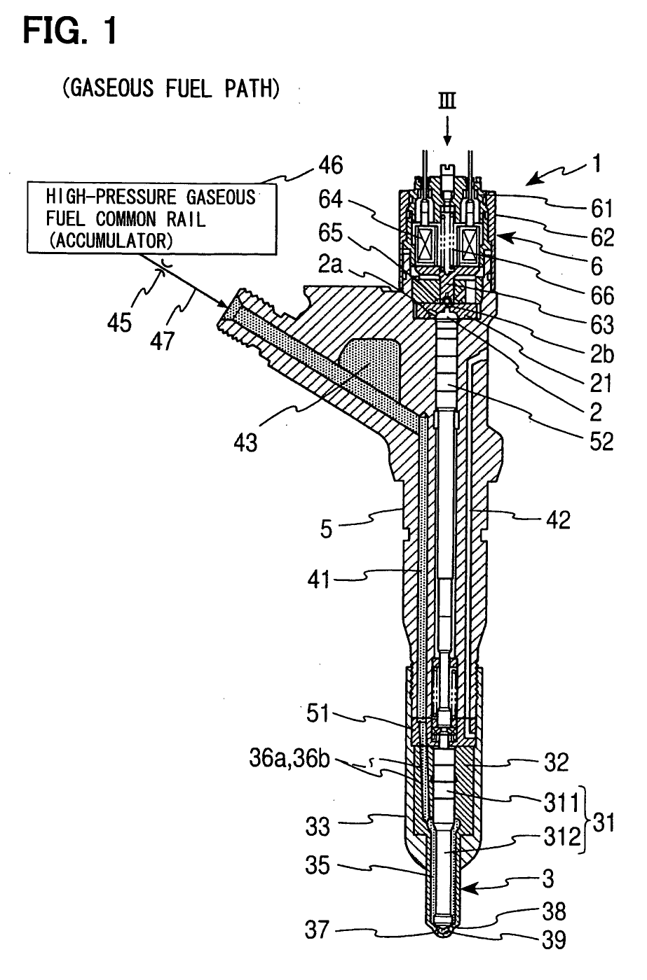

A fuel injector according to a first embodiment of the present invention is described in the following referring to FIG. 1 to FIG. 7D.

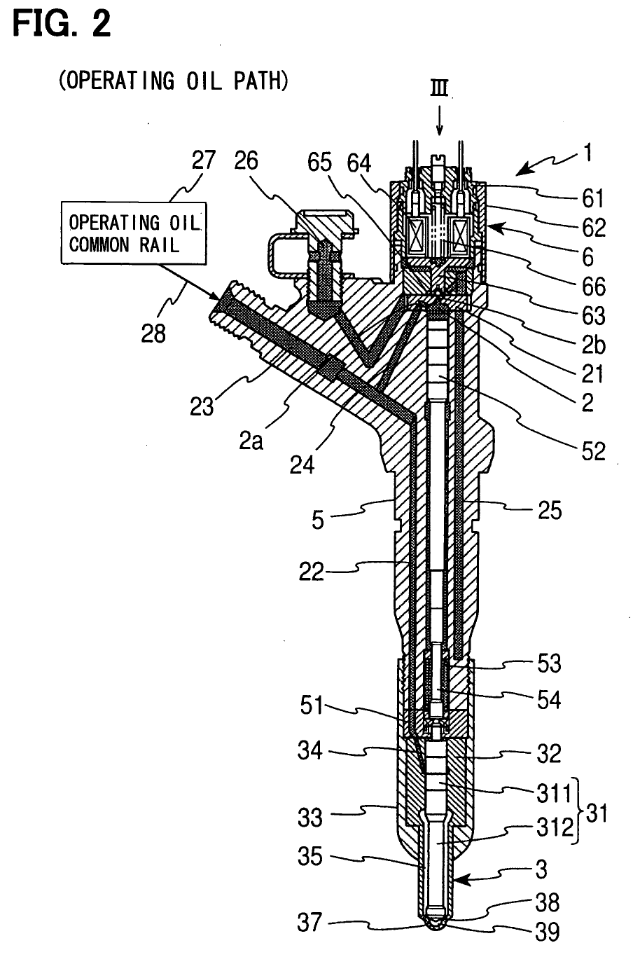

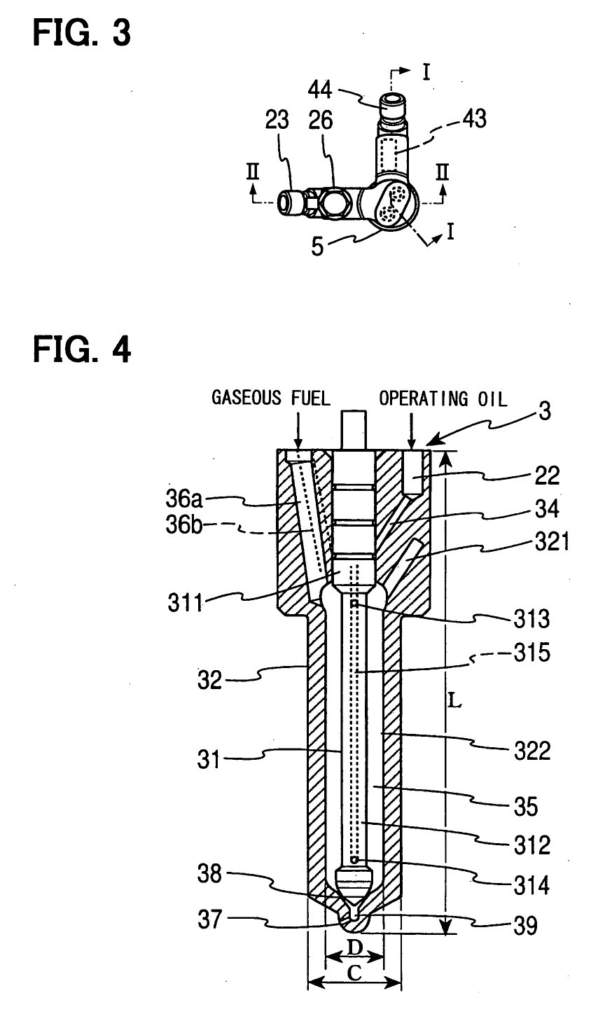

The fuel injector 1 according to the first embodiment is for injecting high-pressure gaseous fuel directly into a cylinder of a multicylinder compression ignition engine. The fuel injector 1 is provided for each cylinder's combustion chamber. FIGS. 1 and 2 are cross-sectional views of the fuel injector 1 taken along its longitudinal direction. FIG. 3 is a top view of the fuel injector 1 that is seen in a direction III in FIG. 1. FIG. 1, which is the cross-sectional view taken along a line I-I in FIG. 3, depicts a gaseous fuel supply path to supply high-pressure gaseous fuel to be injected out of a nozzle 3 of the fuel injector 1. FIG. 2, which is the cross-sectional view taken along a line II-II in FIG. 3, depicts an operating oil supply path to supply operating oil to a control chamber 2 to actuate the nozzle 3. Hydrogen fuel and the like can be used as the high-pressure gaseous fuel. Hydraulic oil and liquid fuel such as light oil can be used for the operating oil.

The fuel injector 1 according to the first embodiments uses the operating oil to perform an on/off control of the pressure in the control chamber 2 in addition to the high-pressure gaseous fuel that is injected. A pressure of the operating oil in the control chamber 2 performs a valve-closing operation of the needle 31 as shown in FIG. 2, and a pressure of the high-pressure gaseous fuel in a nozzle chamber 35 (a volume increase portion in the high-pressure gaseous fuel supply path) performs a valve-opening operation of the needle 31 as shown in FIG. 1. The above-described construction that the fuel injector 1 is provided with the control chamber 2 to apply a valve-closing pressure to the needle 31 is equivalent to a conventional nozzle driving method in a conventional fuel injector for injecting liquid fuel. The nozzle driving method is applied to controlling the pressure in the control chamber 2 for a fuel injection control.

A basic construction of the fuel injector 1 and the operating oil supply path therein are described referring to FIG. 2. The fuel injector 1 is provided with: an injector body 5; a nozzle 3 that is disposed at a lower end side of the injector body 5 to interpose a chip gasket 51 therebetween; and an electromagnetic valve 6 that is an electric switching valve and disposed at an upper end opening of the injector body 5 to interpose an plate member 21 therebetween. A retaining nut 33 screw-fastens the nozzle 3 and the chip gasket 51 integrally to the injector body 5, and a nut 62 screw-fastens the electromagnetic valve 6 integrally to the injector body 5.

The injector body 5 has a cylindrical shape, and a control piston 52 is slidably installed in a cylinder hole in the injector body 5. The control chamber 2 is formed at an upper end side of the control piston 52. In a cylinder wall of the injector body 5 at a side of the control piston 52 are formed two operating oil passages that extend in an axial direction (vertical direction in FIG. 2) thereof not to interfere with other passages. One of the operating oil passages serves a high-pressure oil passage 22, and the other serves an oil return passage 25. The high-pressure oil passage 22 is communicated with an oil inflow pipe 23 that is disposed to protrude obliquely over an upper portion the injector body 5. The oil inflow pipe 23 is communicated via an oil supply pipe 28 with an operating oil common rail 27 that accumulates the operating oil at a specific pressure. The above-described passages form the operating oil supply path. The oil return passage 25 is communicated with an operating oil tank (not shown) via an oil outflow pipe 26 that is disposed to protrude obliquely over the upper portion the injector body 5.

In the nozzle 3, a longitudinal hole, which is formed in the nozzle body 32 in its longitudinal direction, slidably supports a needle 31 having a stepped circumferential face. An upper end portion of the needle 31 is coupled to a lower end portion of the control piston 52 so that the needle 31 and the control piston 52 integrally move with each other. A return spring 53, which is disposed in a spring room 54 formed around an outer circumference of the lower end portion of the control piston 52, urges the needle 31 downward. A lower end of the high-pressure oil passage 22 is communicated with a lubrication passage 34 to supply the operating oil as lubricating oil to a large diameter guide portion 311 of the needle 31. A lower end of the oil return passage 25 is communicated with the spring room 54 to recover the leakage oil from respective portions in the fuel injector 1 and drain the leakage oil out of the oil outflow pipe 26.

The plate member 21 is installed inside the upper end opening of the injector body 5 to block the cylinder hole in which the control piston 52 slides. The control chamber 2 is defined by an upper end face of the control piston 52, an inner circumferential face of the cylinder hole and a depressed portion of the plate member 21 that is formed at a center on a lower end face of the plate member 21. The control chamber 2 is communicated with a high-pressure passage 24 that is branched from the high-pressure oil passage 22 via an inlet aperture 2a at all times. The pressure in the control chamber 2 acts downward on the needle 31 via the control valve 52. The control chamber 2 is communicated also with the oil return passage 25 via an outlet aperture 2b. The electromagnetic valve 6 connects and interrupts the communication between the control chamber 2 and the oil return passage 25 to increase and decrease the pressure in the control chamber 2.

The electromagnetic valve 6 has a solenoid body 61, a cylinder-shaped solenoid 64 installed in the solenoid body 61 and a control valve 63. The control valve 63 has: an armature that has a T-shaped cross-section and faces a lower end face of the solenoid 64; and a ball valve that is supported in a hemispherical depression formed at a leading end portion of the armature. A low-pressure passage 65 is provided around the leading end portion of the armature to communicate the outlet aperture 2b with the oil return passage 25. When the control valve 63 is not energized, a spring 66 that is disposed in the solenoid 64 urges the control valve 63 downward so that the ball valve blocks the outlet aperture 2b of the control chamber 2.

FIG. 1 shows the gaseous fuel supply path to supply the high-pressure gaseous fuel to injection holes 37 that are formed at a leading end of the nozzle 3. The longitudinal hole in the nozzle body 32 around a small diameter stem 312 of the needle 31 is extended radially outward to provide an annular nozzle chamber 35. A sac 39 is provided below the nozzle chamber 35. The injection holes 37 are formed to penetrate a wall enclosing the sac 39. In the cylinder wall of the injector body 5 are formed two gaseous fuel passages that extend in the axial direction (vertical direction in FIG. 1) thereof. One of the gaseous fuel passages serves a high-pressure gas passage 41, and the other serves a gas return passage 42. The high-pressure gas passage 41 is communicated with a gas inflow pipe 44 that is disposed to protrude obliquely over the upper portion the injector body 5. The gas inflow pipe 41 is communicated via a gas supply pipe 47 and an aperture 45 with a high-pressure gaseous fuel common rail (or gas accumulator) 46 that corresponds to a high-pressure gaseous fuel accumulator according to the present invention. The gas return passage 42 is communicated with a gaseous fuel tank (not shown) via an outlet port provided on a side face of the injector body 5. As shown in FIG. 3, seen in the axial direction of the injector body 5, the gas inflow pipe 44 and the oil inflow pipe 23 form an angle of 90 degrees. The above-described passages form the gaseous fuel supply path.

In order to inject a large amount of gaseous fuel having relatively small density in a short time, it is desirable that the gaseous fuel supply path is provided with a plurality of the volume increase portions in which a cross-sectional area of the gaseous fuel supply path rapidly increases. In the first embodiment, a thick-walled portion of the cylinder wall of the injector body 5 has a cavity therein to provide the gaseous fuel supply path between the gas inflow pipe 44 and the high-pressure gas passage 41 with an injector chamber (a second volume increase portion) 43. Further, as described above, the stem 312 of the needle 31 upstream the injection holes 37 and the nozzle body 32 around the stem 312 provide the nozzle chamber 35 therebetween. Furthermore, in order to supply the high-pressure gaseous fuel fast to the nozzle chamber 35, the nozzle body 32 is provided with a plurality of feed passages 36a, 36b that are connected to the high-pressure gas passage 41, so that a large amount of the high-pressure gaseous fuel can be supplied to the nozzle chamber 35.

When a valve-open command by a control unit (not shown) loads a driving current in the solenoid 64 of the electromagnetic valve 6 to lift up the control valve 63 against a spring force of the spring 66, the outlet aperture 2b of the control chamber 2 opens. By the valve-open of the control valve 63, the high-pressure gaseous fuel in the control chamber 2 is discharged via the outlet aperture 2b and the low-pressure passage 65 to the oil return passage 25. The outlet aperture 2b, which regulates a outflow of the high-pressure gaseous fuel from the control chamber 2 to the low-pressure passage 65, has a cross-sectional area larger than that of the inlet aperture 2a, which regulates an inflow of the high-pressure gaseous fuel from the high-pressure passage 24 into the control chamber 2, so that the valve-open of the control valve 63 decreases the pressure in the control chamber 2.

When the pressure in the control chamber 2 decreases, a force to push down the control piston 52 and the needle 31 decreases, and the force of the high-pressure gaseous fuel in the nozzle chamber 35 to push up the needle 31 exceeds a resultant force of the return spring 53 and the operating oil in the control chamber 2 to push down the needle 31. Accordingly, the needle lifts up so that the seat portion 38 moves off the nozzle body 32, and the high-pressure gaseous fuel in the nozzle chamber 35 flows to the sac 39 to be injected out of the injection holes 37 into the combustion chamber of the engine. As described above, by the construction provided with the control chamber 2 that applies backpressure on the needle 31 so that the high-pressure operating oil actuates the control piston 52, a relatively large driving force is generated to actuate the needle 31 speedily.

A detailed construction of the nozzle 3 is described in the following referring to FIG. 4. The needle 31 has an approximately conical outer face at a leading end thereof. The pressure in the control chamber 2 (refer to FIG. 1) and the spring force of the return spring 53 urge the needle 2 downward to push the seat portion 38 on the conical outer face onto an inner circumferential face of the nozzle body 32. At this time, the seat portion 38 of the needle 31 interrupts a communication between the nozzle chamber 35 and the sac 39, and no high-pressure gaseous fuel is injected out of the injection holes 37, which is communicated with the sac 39, into the combustion chamber of the engine.

As described above, the nozzle chamber 35 is provided in a lower half portion of the nozzle body 32, in which an outer diameter of the needle 31 is decreased and an inner diameter 322 of the nozzle body 5 is extended radially outward, to increase a volume of the high-pressure gaseous fuel accumulated therein. Specifically, the inner diameter of the lower half portion of the nozzle body 5 is larger than the inner diameter of the sliding portion 311 of the needle 31. The outer diameter of the stem 312 of the needle 31 is smaller than the maximum outer diameter of the leading end portion of the needle 31 (for example, the outer diameter of the stem 312 is approximately as small as the outer diameter at the seat portion 38).

Further, the needle 31 has a needle chamber hole 315 that is formed in its stem 312 in its longitudinal direction. The nozzle chamber opens to the nozzle chamber 35 at communication holes 313, 314 that are provided at an upper and an lower end portions of the stem 312. Furthermore, the nozzle body 32 may be provided with an additional chamber 321 that is communicated with the upper end portion of the nozzle chamber 35. The needle chamber hole 315 and the additional chamber 321 serve a volume increase of the high-pressure gaseous fuel accumulated in the nozzle 3. Further volume increase means may be incorporated in the nozzle 3 to increase the volume of the high-pressure gaseous fuel accumulated in the nozzle 3.

It is desirable that a total cross-sectional area of the gaseous fuel supply path in the volume increase portion in the nozzle body 32 (a summation of a cross-sectional area of the nozzle chamber 35 and a cross-sectional area of the needle chamber hole 315) is between once to ten times a difference between a cross-sectional area of the stem 312 and the cross-sectional area of the needle chamber hole 315 ((cross-sectional area of the stem 312)−(cross-sectional area of the needle chamber hole 315)). A large volume of the nozzle chamber 35 secures a large amount of the high-pressure gaseous fuel just upstream the injection holes 37. In order to secure an enough amount of the high-pressure gaseous fuel in the fuel injector 1 for each fuel injection, it is desirable that the injector chamber 43, which is provided on the way of the high-pressure gas passage 41, has a large volume on the order of several square centimeters.

In the first embodiment, two feed passages 36a, 36b are formed in the nozzle body 32 to supply the high-pressure gaseous fuel from the high-pressure gas passage 41 to the nozzle chamber 35. The feed passages 36a, 36b are formed at the side of the guide portion 311 of the needle 31 and open to the upper end portion of the nozzle chamber 35. More than two feed passages 36a, 36b are necessary to increase the volume of the high-pressure gaseous fuel in the nozzle body 32 and to allocate large inner diameters for them.

An amount of the high-pressure gaseous fuel that is supplied to the internal combustion engine must have accuracy in accordance with a target amount. The pressure of the high-pressure gaseous fuel in the gaseous fuel supply path in a leading portion region of the injector 1 (especially in the nozzle body 32) is required to be within a specific margin of fluctuation over a time from an injection start to an injection stop. An excessively large fluctuation of the pressure of the high-pressure gaseous fuel occurs an uneven fuel injection amount. In the present invention, the gaseous fuel supply path in the nozzle 3 is provided with the volume increase portion so that the fuel injection amount per one injection in intermittent injections, which repeats injection starts and injection stops, corresponds to the target amount in respective operation ranges. The volume increase portion has dimensions in view of the one injection volume.

The above-described range between once and ten times is determined in view of the conditions below. The injector 1 according to the present invention is for the vehicles of the next generation and has dimensions as follows. As shown in FIG. 4, a longitudinal length L of the nozzle body 32 is between 24 mm and 40 mm. An outer diameter C of the nozzle body 32 is between 7 mm and 9.2 mm. An inner diameter D of the nozzle body, in which the needle 31 is installed, is between 3.9 mm and 4.9 mm. The above-described dimensions are based on the nozzle body 32 made of chromium molybdenum steels and the needle 31 made of high speed tool steels.

In the above-described conditions, the minimum ratio (once) in the above-described range is determined to secure a required injection performance to inject the high-pressure gaseous fuel. The maximum ratio (ten times) in the above-described range serves the large volume increase portion, and is determined in view of the limited size and material strength of the components of the injector 1. The range between once and ten times corresponds to a range between 0.2 times and 0.5 times in conventional fuel injectors.

In the nozzle body 32 is formed the lubrication passage 34 at the side of the guide portion 311 of the needle 31 to open to the longitudinal hole in which the guide portion 311 slides. The guide portion 311 is provided with a plurality of lubrication grooves on its outer circumferential face, into which the high-pressure operating oil is supplied from the high-pressure oil passage 22 via the lubrication passage 34 to lubricate sliding surfaces on the guide portion 311 and the nozzle body 32. The high-pressure gaseous fuel in the nozzle body 32 pushes the operating oil, which lubricates the guide portion 311, upward from the guide portion 311 to leak into the spring room 54 in the injector body 5 and to be recovered through the oil return passage 25 to the oil outflow pipe 26.

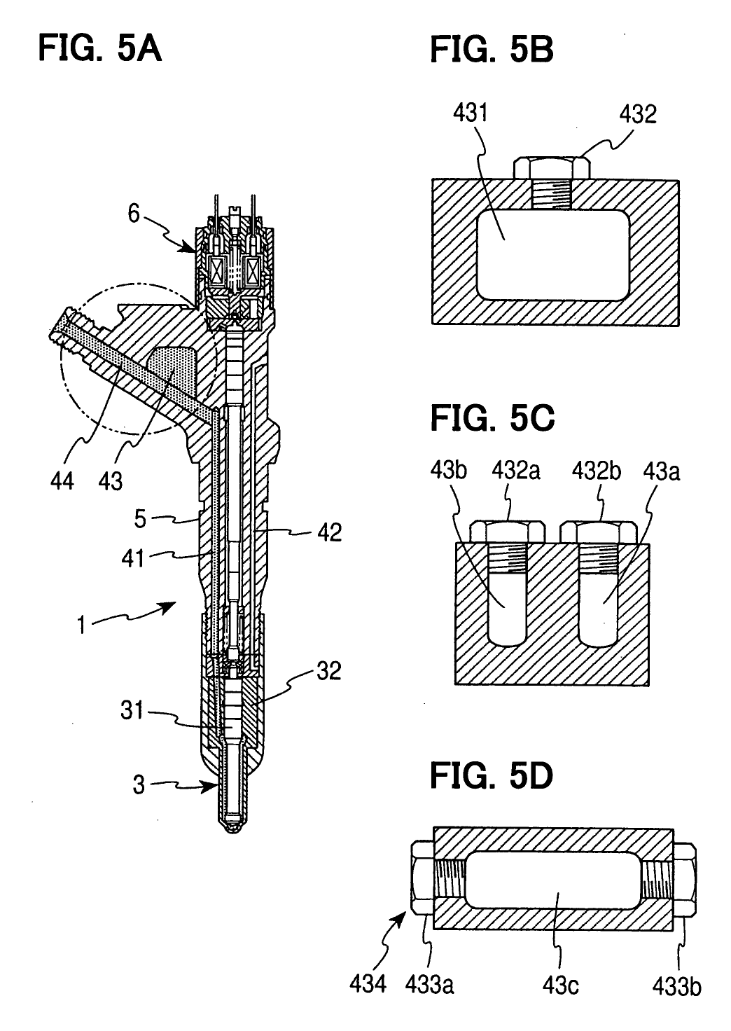

An example to form the injector chamber 43 in the injector device 1 is described referring to the FIG. 5A. FIG. 5A depicts main portions of the gaseous fuel supply path. As described above, in the first embodiment, the thick-walled portion of the cylinder wall of the injector body 5, in which the gas inflow pipe 44 is disposed, is provide with the cavity as the injector chamber 43 to be communicated with the high-pressure gas passage 41. The injector chamber 43 can be formed in the injector body 5 by salt coacervation in casting, core deposition in sintering, lost wax process, and so on.

Alternative examples to form the injector chamber 43 in the injector device 1 are described referring to the FIGS. 5B to 5D. FIG. 5B shows an example in which a chamber 431 formed by lathing work and the like serves the injector chamber 43 and a screw plug 432 seals an opening of the chamber 431. FIG. 5C shows another example in which depressed portions 43a, 43b formed by forging serves the injector chamber 43 and screw plugs 432a, 432b seal screw holes 432a, 432b bored to the depressed portions 43a, 43b. FIG. 5D shows still another example in which an additional chamber member 434, which has a chamber 43c therein, is disposed between the injector 1 and the high-pressure gaseous common rail 46 instead of providing the injector chamber 43 in the injector 1. Connectors 433a, 433b connects the additional chamber member 434 to the injector 1, to the high-pressure gaseous fuel common rail 46 and to the gas inflow pipe 44. It is desirable that the chamber 43c is disposed in close proximity to the injector 1.

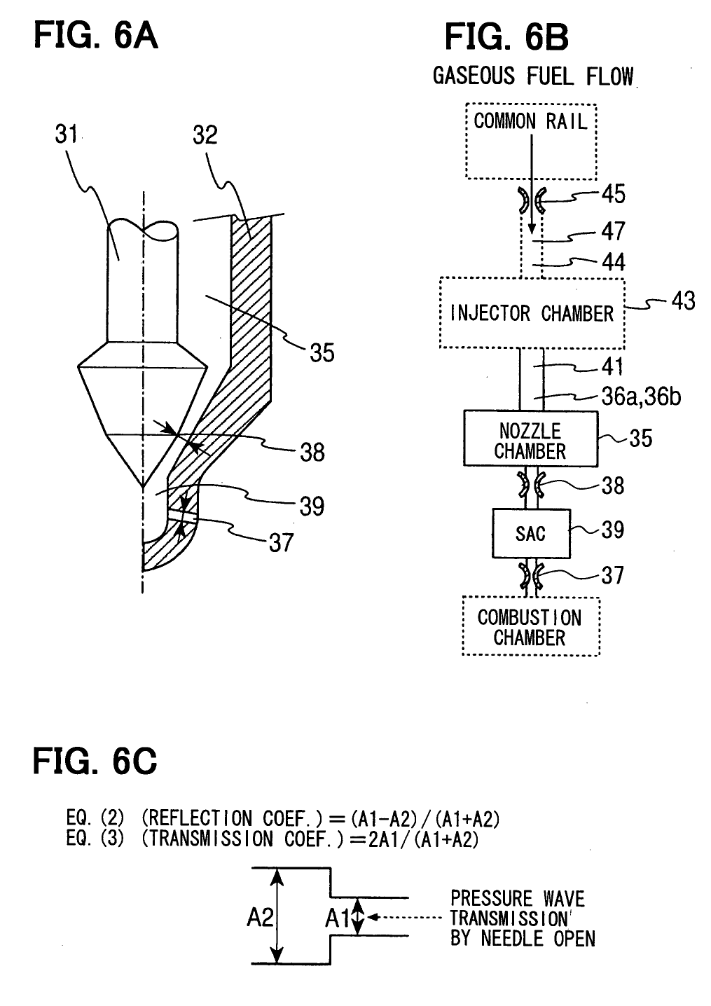

In the first embodiment, a plurality of the volume increase portions (chambers) provided in the gaseous fuel supply path enable to secure a required injection amount and to keep a large injection pressure. Constructions and functions of respective chambers are described in the following with reference to FIGS. 6A to 6C. FIG. 6B schematically depicts the positions and volumes of the chambers and apertures (narrow passages) disposed in the gaseous fuel supply path from the high-pressure gaseous fuel common rail 46 to the combustion chamber of the engine. A change of the cross-sectional area at the aperture splits a pressure wave, which is transmitted in the gaseous fuel supply path, into a reflection wave and a transmission wave. FIG. 6C shows formulae that represent magnitudes of the reflection wave and the transmission wave in relation to the cross-sectional areas A1, A2 of the gaseous fuel supply path.

At the injection start by a valve-open of the needle 31 shown in FIG. 6A, the high-pressure gaseous fuel in the high-pressure gas passage 41 flows downward toward the injection holes 37. At the injection start time, a pressure difference between an initial pressure and a pressure wave, which is represented by a formula (1) below, (=(Initial pressure)−(Pressure wave)) is transmitted from the seat portion 38 to the nozzle chamber 35 upstream the seat portion 38.
(Pressure wave)=(Gas density)×(Sound velocity)×(Outflow speed) (1)

That is, the pressure wave is transmitted leftward in FIG. 6C (in a direction represented by an arrow in the figure). The reflection wave has a negative value against a positive incident wave as represented by a formula (2) below, wherein A2 is larger than A1.
(Reflection coefficient)=(A1−A2)/(A1+A2) (2)

That is, the pressure wave that is smaller than the initial pressure is reversed between positive and negative by the nozzle chamber 35 and reflected to the seat portion 38 at a pressure increased from the initial pressure by a product of the formulae (1) and (2). Thus, an actual injection pressure at the injection start time is prevented from decreasing and a high-pressure injection is kept.

A further continuous fuel injection decreases the initial pressure by the injection of the high-pressure gaseous fuel in the nozzle chamber 35. The injector chamber 43 having a large volume and disposed upstream the nozzle chamber 35 continuously supplies the high-pressure gaseous fuel to refills the nozzle chamber 35. Thus, the pressure in the nozzle chamber 35 is prevented from decreasing. The volume of the injector chamber 43 around 2 mm³ or 3 mm³ is enough to obtain the above-described effect, although it depends on a kind of the gaseous fuel and dimensions of the internal combustion engine. For example, in a case that the high-pressure gaseous fuel is a hydrogen fuel supplied at a pressure of 60 MPa and a displacement per one cylinder is 2000 cm³, the volume of the injector chamber 43 around 5 cm³ to 10 cm³ is ordinarily enough to prevent the pressure in the nozzle chamber 35 from decreasing.

The injector chamber 43 is continuously supplied with the high-pressure gaseous fuel from the high-pressure gaseous fuel common rail 46 via the high-pressure gas inflow pipe 44 and the gas supply pipe 47. Thus, the pressure in the injector chamber 43 is also prevented from decreasing. As shown in FIG. 6C, the pressure wave transmitted from the seat portion 38 is pursuant to a transmission coefficient represented by a formula (3) below, and transmitted via the nozzle chamber 35 and the injector chamber 43 to the high-pressure gaseous fuel common rail 46.
(Transmission coefficient)=2A1/(A1+A2) (3)

Thus, without further measure, the pressure wave is transmitted to other cylinders to occur pressure interference to fluctuate the fuel injection in the other cylinders. In the first embodiment, an aperture 45 is provided in the gas supply pipe 47 in a close proximity to the high-pressure gaseous fuel common rail 46. A relation between cross-sectional areas of the gas supply pipe 47 and the aperture 45, and a relation between cross-sectional areas of an open port of the high-pressure gaseous fuel common rail 46 and the aperture 45 are determined in accordance with the above-described formulae (2) and (3). That is, a transmission wave passing through the aperture 45 pursuant to the formula (3) is reflected at the open port of the high-pressure gaseous fuel common rail 46, which is an open-end pursuant to the equation (2). The cross-sectional area of the aperture 45 is determined so that the reflection wave reflected at the open port of cancels the transmission wave transmitted through the aperture 45 again, that is, so that a positive and negative phases of the reflection and transmission wave compound with each other. Thus, the pressure wave is prevented from being transmitted through the high-pressure gaseous common rail 46 to other cylinders. Each of the aperture 45 and other apertures has a length that does not occur a phase contrast between the transmission wave transmitted therethrough and the reflection wave reflected thereat. That is, the length is determined so that ((length of aperture)/(sound speed)) can be negligible to keep the phase contrast at 180 degrees between the transmission and reflection waves, which have reversed phases to each other.

As described above, the high-pressure gas passage in the fuel injector 1 has the volume extension portions (the nozzle chamber 35 and the injector chambers 43), and the high-pressure gas passage outside the fuel injector 1 has the aperture 45 at the close proximity to the high-pressure gaseous fuel common rail 46 that has a large volume. This construction serves both a first effect to inject required amount of the high-pressure gaseous fuel without decreasing the injection pressure from the injection hole 37 and a second effect to absorb the pressure wave that occurs at the seat portion 38 in the fuel injection time so as not to affect fuel injections in other cylinders concurrently. Further, the fuel injector 1 has the control chamber 2 so that the high-pressure operating liquid actuates the needle 31. This construction serves both relatively small dimensions of the fuel injector 1 and large driving force to improve injection control performance.

In FIGS. 6A and 6B, a pressure variation downstream the seat portion 38 is evaluated as follows. By the valve-open of the needle 31, the high-pressure gaseous fuel flows from the seat portion 38 toward the sac 39 and the injection hole 37 located downstream the seat portion 38 (lower side in FIGS. 6A and 6B) and is injected out of the injection hole 37. A flow path from the seat portion 38 to the injection hole 37 is relatively short and a variation of the cross-sectional area over the flow path is relatively small as compared with that upstream the seat portion 38. Thus, as described above, the fuel pressure flowing into the seat portion 38 can represent the fuel pressure downstream the seat portion 38. Alternatively, the cross-sectional area of the flow path in the sac 39, the injection hole 37 and the seat portion 38 may be defined in accordance with the above-described relation to serve the effect to prevent the pressure from decreasing.

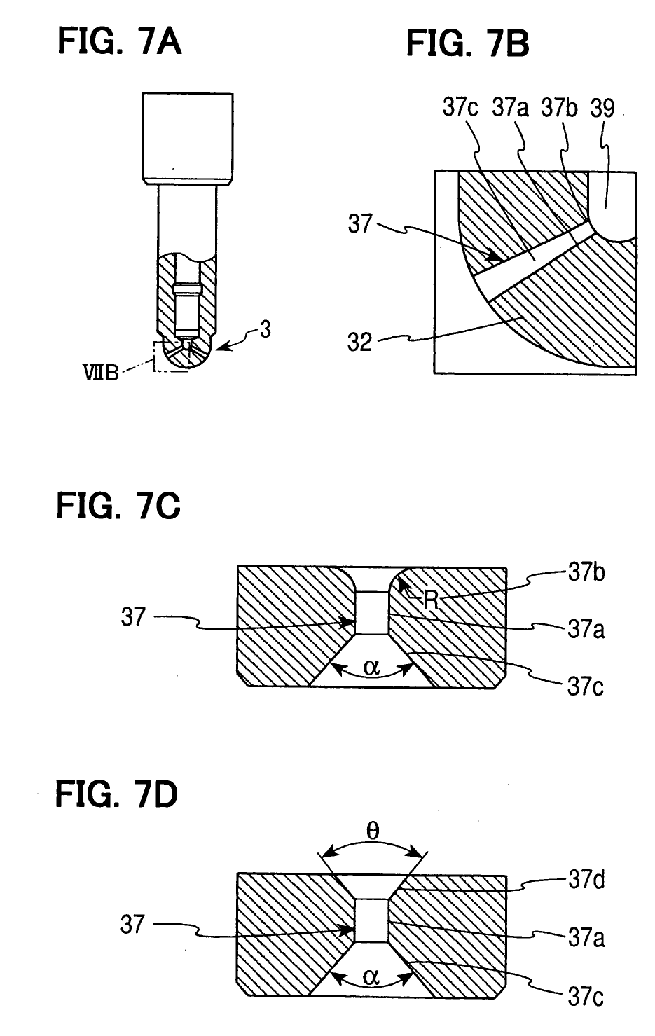

A shape of the injection hole 37 that enables high-speed fuel injection is described in the following referring to FIGS. 7A to 7D. FIG. 7B schematically depicts the shape of the injection hole 37 of the nozzle 3 in detail, which corresponds to a range VIIB in FIG. 7A. FIG. 7C schematically depicts a cross-sectional shape of the injection hole 37. As shown in FIGS. 7B and 7C, the injection hole 37 has: a rounded portion 37b at its inflow side opening that is communicated with the sac 39; and a tapered portion 37c at its outflow side opening that opens to the combustion chamber of the engine. The tapered portion 37c is shaped so that a diameter of the injection hole 37 gradually increases in a fuel flow direction. The shape of the injection hole 37 and the high-pressure gaseous fuel enable the high-speed fuel injection. Specifically, when a pressure ratio (downstream pressure/upstream pressure) is below a critical pressure ratio by increasing a pressure difference between the pressure in the sac 39 upstream the injection hole 37 and a pressure in the combustion chamber, the flow speed of the gaseous fuel passing through a throat portion 37a, in which the diameter of the injection hole 37 is narrowest, reaches the sound speed to be choking state. The fuel flow speed in the throat portion 37a is independent from the fuel flow state in a downstream portion in the injection hole 37. Once the fuel flow speed reaches the sound speed, the fuel flow speed does not change from the sound speed, provided the pressure difference is large (the pressure ratio is below the critical pressure ratio). Then, the cross-sectional area extension in the tapered portion 37c forms a high-speed gaseous fuel injection flow that is injected faster than the sound speed.

It is better that a rounding radius of the rounded portion 37b is larger than the minimum diameter of the injection hole 37, although the rounding radius may be either smaller than the minimum diameter of the injection hole 37 or larger than the minimum diameter to serve the above-described effect. It is desirable that a tapering angle α of the tapered portion 37c is smaller than 20 degrees, more desirably between 5 degrees and 10 degrees to decrease an injection pressure loss.

As shown in FIG. 7D, another tapered portion 37d may substitute for the rounded portion 37b (shown in FIG. 7C) at the inflow side opening of the injection hole 37. It is desirable that the tapering angle θ of the tapered portion 37d is generally equivalent to the tapering angle α of the tapered portion 37c. It is desirable that the tapered portions 37c, 37d have enough length in the fuel flow direction, specifically three times of a length of the throat portion 37a or larger.

### Second Embodiment

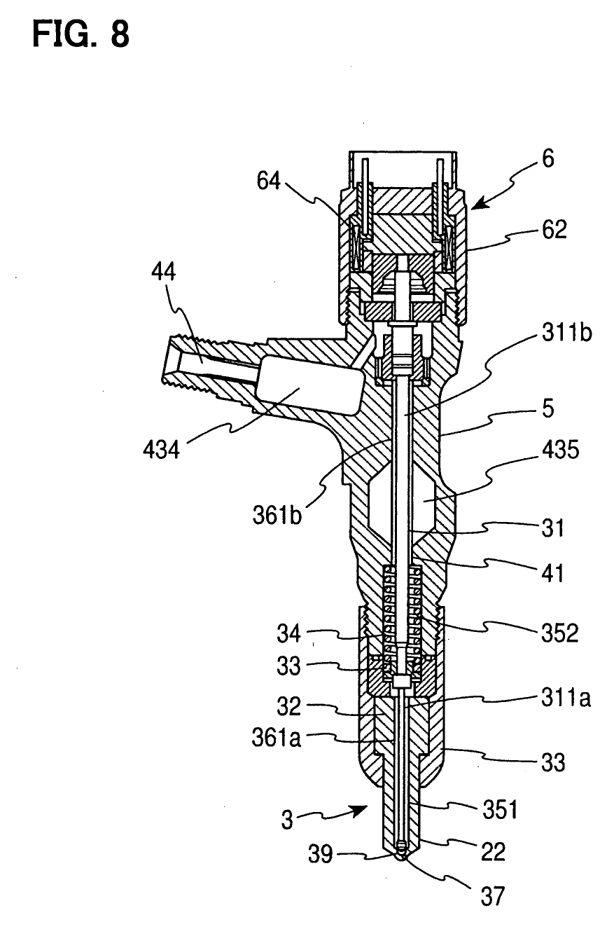

FIG. 8 depicts a cross-sectional view of the fuel injector 1 according to a second embodiment of the present invention, in which a solenoid 64 of an electromagnetic valve 6 directly actuates a needle 31 to inject the high-pressure gaseous fuel from the nozzle 3. Other components of the fuel injector 1 according to the second embodiment are substantially equivalent to those in the first embodiment. The components that are common to the first and the second embodiments are assigned the same referential numerals. In the following is mainly described differentia from the first embodiment.

As shown in FIG. 8, a retaining nut 33 screw-fastens a nozzle 3 integrally to a lower-end side of a cylinder-shaped injector body 5, and a nut 62 screw-fastens the electromagnetic valve 6 integrally to an upper end opening of the injector body 5, to form the fuel injector 1. The nozzle body 32 slidably supports a needle 31 therein. An upper end of the needle 31 extends upward through the injector body 5 and reaches a lower end of the electromagnetic valve 6.

In the second embodiment, a high-pressure gas passage 41 is provided by a clearance between an inner face of the injector body 5 and an outer face of the needle 31. The high-pressure gas passage 41 is communicated via a gas inflow pipe 44 to a high-pressure gaseous fuel common rail (not shown). The high-pressure gas passage 41 has a plurality of injector chambers 434, 435 on its way. A first injector chamber 434 is provided in a cylinder wall of the injector body 5 by extending a width of the high-pressure gas passage 41 downstream the gas inflow pipe 44. A second injector chamber 435 is provided by cylindrically recessing an inner circumferential face of the injector body 5 around the needle 31. In the second embodiment, the needle 31 has two guide portions 311a, 311b. A first guide portion 311a slides in the nozzle body 32 and a second guide portion 311b slides in the injector body 5. Outer circumferences of the guide portions 311a, 311b are chambered at their two sides opposite from each other, so as to provide a first feed passage 361a communicated with the second injector chamber 435 and a second feed passage 361b communicated with a first nozzle chamber 351.

In the second embodiment, a nozzle 3 has a plurality of the nozzle chambers 351, 352 therein. The first nozzle chamber 351 has a construction equivalent to that of the nozzle chamber 35 in the first embodiment. A second nozzle chamber 352 is formed at an upper end portion of the nozzle that adjoins the injector body 5. The second nozzle chambers 352 also serve a spring room installing a spring 53 therein. A leading end of the high-pressure gas passage 41 is communicated with the second nozzle chamber 352, so as to feed the high-pressure gaseous fuel via the first feed passage 361a to the first nozzle chamber 351.

The construction of the fuel injector 1 according to the second embodiment requires no operating oil supply path and no control chamber, so that the construction of the fuel injector 1 is simple. Further, a plurality of the injector chambers 434, 435 and a plurality of the nozzle chambers 351, 352 can be formed in the fuel injector 1, so that an effect to keep the gaseous fuel pressure is improved. The fuel injector 1 has an enough volume to supply a maximum fuel injection amount in a large engine. For example, an injection of 2.5 cm³ of hydrogen fuel at a pressure of 60 MPa corresponds to that of 250 mm³ of light oil from a viewpoint of output energy. In this case, 10 cm³ of the volume of the chamber is enough and a pressure drop occurred by the injection is 15 MPa or smaller. Practically, the pressure drop is limited by the gaseous fuel supply from the high-pressure gaseous fuel common rail 46.

The shape of the chambers such as cylindrical one, rectangular hole, and so on and the number of the chambers may be selected in accordance with demands. It is desirable that the chamber is disposed close to the injection holes 37 of the nozzle 3. The chamber, which is disposed so that the sound speed can travel between the injection holes 37 and the chamber in each injection period, is effective for increasing the fuel injection amount.

By the construction of the fuel injector 1 according to the above-described embodiments that injects the high-pressure gaseous fuel directly into the cylinder of the engine, a plurality of the chambers 315, 321, 35 (351, 352), 43 (431, 43a, 43b, 43c, 434, 435) formed in the injector 1 enables its large output power to inject a large amount of the high-pressure gaseous fuel in a short time. The arrangement of the apertures enables a continuous fuel supply from the high-pressure gaseous common rail (or accumulator) upstream the injector 1 by use of the negative pressure wave that occurs at the injection start to induce the gaseous fuel. Further, the construction to flow the high-pressure gaseous fuel passes through the injection hole at the sound speed enables to inject the gaseous fuel having large pressure and large density and to promote a mixture of the gaseous fuel and the air. The high-speed fuel injection and large amount fuel supply from the chambers with little pressure drop realizes the fuel injector 1 that can inject the high-pressure gaseous fuel in a short time. Accordingly, the fuel injector 1 according to the above-described embodiments enables: a large volume injection because of a small density of the gaseous fuel; and highly diffused injection to mix the gaseous fuel with the air in the combustion chamber with reliability. Thus, the fuel injector 1 according to the above-described embodiments enables both a large output power of the engine and a reduction of unburnt fuel emission.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel injector for injecting high-pressure gaseous fuel into a combustion chamber of an internal combustion engine, the injector comprising:
an inlet port through which the high-pressure gaseous fuel is supplied;
an injection hole through which the high-pressure gaseous fuel is injected;
a gaseous fuel supply path that extends from the inlet port to the injection hole to flow the high-pressure gaseous fuel therethrough;
a needle that opens or closes the injection hole; and
an actuator that actuates the needle,
wherein the gaseous fuel supply path is provided with a first volume increase portion at which a cross-sectional area of the gaseous fuel supply path rapidly increases as going from the injection hole toward the inlet port.

2. The fuel injector according to claim 1, wherein a volume of the volume increase portion is determined so that a variation of an injection pressure at which the high-pressure gaseous fuel is injected through the injection hole is within a predetermined target value during a time from a start to a stop of each injection in a series of injections to inject the high-pressure gaseous fuel through the injection hole.

3. The fuel injector according to claim 1, wherein the first volume increase portion is disposed upstream a seat portion of the needle.

4. The fuel injector according to claim 3, wherein:
the volume increase portion is formed at least one of a space around the needle or a cavity formed in the needle; and
a cross-sectional area of the first volume extension portion is between once and ten times a cross-sectional area of the needle.

5. The fuel injector according to claim 1, wherein the gaseous fuel supply path between the inlet port and the first volume increase portion is further provided with a second volume increase portion at which the cross-sectional area of the gaseous fuel supply path rapidly increases as going from the first volume increase portion toward the inlet port.

6. The fuel injector according to claim 1, further provided with an aperture at a close proximity to the inlet port.

7. The fuel injector according to claim 1, wherein the injection hole is shaped so that a diameter thereof gradually increases from an inflow side opening toward an outflow side opening thereof.

8. The fuel injector according to claim 1, wherein the actuator is provided with:
a control chamber that accumulates an operating oil therein to apply an actuating pressure to the needle;
an operating oil supply path that supplies the operating oil into the control chamber; and
an electric switch valve that controls a flow of the operating oil into and out of the control chamber.
